(19) United States
(12) Patent Application Publication
(10) Pub. No.: US 2024/0072910 A1
(43) Pub. Date: Feb. 29, 2024

(54) AUDIO TRANSMISSIONS WITH INTERLEAVED DATA PAYLOADS

(71) Applicant: LISNR,INC., Cincinnati, OH (US)

(72) Inventor: Oz MENDEL, Piedmont, CA (US)

(21) Appl. No.: 18/239,440

(22) Filed: Aug. 29, 2023

Related U.S. Application Data
(60) Provisional application No. 63/401,834, filed on Aug. 29, 2022.

(51) Int. Cl. H04B 11/00; H04L 1/00

(52) U.S. Cl. CPC H04B 11/00; H04L 1/0071

(57) ABSTRACT

Methods and systems for improved transmission of data using audio signals are provided. In one embodiment, a method is provided that includes receiving data for transmission within an audio environment and interleaving the data. The interleaved data may be modulated into multiple audio symbols to form an audio transmission. An audio signal may be generated based on, and the audio signal may be transmitted within the audio environment. In another embodiment, a method is provided that includes detecting an audio transmission within an audio signal from an audio environment. The audio transmission may be extracted, and a data payload of the audio transmission may be identified. The data payload may be deinterleaved (e.g., according to a predetermined interleaving protocol). The deinterleaved data may be decoded, allowing data to be extracted.

### CROSS REFERENCE TO RELATED APPLICATIONS

The present application claims priority to U.S. Provisional Application 63/401,818 filed Aug. 29, 2022, which is incorporated herein by reference.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another.

In some instances, it may be desirable to transmit data between computing devices without connecting both devices to the same computing network to enable identification of a person, or group of persons, located in particular proximity to one or more of the devices.

### SUMMARY

The present disclosure presents new and innovative systems and methods for transmitting data using audio transmissions. In some aspects, the techniques described herein relate to a method that includes receiving data for transmission within an audio environment; interleaving the data to form interleaved data; modulating the interleaved data into a plurality of audio symbols to form an audio transmission; generating an audio signal containing the plurality of audio symbols; and transmitting the audio signal within the audio environment.

In some aspects, the techniques described herein relate to a method wherein interleaving the data includes interleaving the data with supplementary data to form the interleaved data.

In some aspects, the techniques described herein relate to a method wherein the supplementary data is a random data sequence with the same length as the data.

In some aspects, the techniques described herein relate to a method wherein the supplementary data is a unique identifier associated with the data.

In some aspects, the techniques described herein relate to a method wherein interleaving the data includes dividing the data into a plurality of data segments and interleaving the plurality of data segments to form the interleaved data.

In some aspects, the techniques described herein relate to a method wherein the data is divided into at least three data segments.

In some aspects, the techniques described herein relate to a method wherein interleaving the data includes reversing at least one of the plurality of data segments.

In some aspects, the techniques described herein relate to a method wherein the data is modulated into audio symbols before being interleaved to form the interleaved data.

In some aspects, the techniques described herein relate to a method wherein the data is encoded according to a predetermined encoding protocol before being interleaved to form the interleaved data.

In some aspects, the techniques described herein relate to a method further including, prior to interleaving the data, generating an error checking code for the data and wherein interleaving the data includes interleaving the error checking code with the data to form the interleaved data.

In some aspects, the techniques described herein relate to a method wherein the interleaved data is combined with header information before being modulated to form the audio transmission.

In some aspects, the techniques described herein relate to a method wherein the header information indicates that a data payload was interleaved.

In some aspects, the techniques described herein relate to a method wherein the data is interleaved according to a predetermined interleaving protocol and wherein the header information is generated to indicate the predetermined interleaving protocol.

In some aspects, the techniques described herein relate to a method wherein the predetermined interleaving protocol specifies one or more of a symbol length of the audio symbols, a number of interleaved data segments, a length of a supplementary data segment, and/or an ordering of the interleaved data.

In some aspects, the techniques described herein relate to a system including a processor and a memory storing instructions which, when executed by the processor, cause the processor to receive data for transmission within an audio environment; interleave the data to form a data payload; modulate the data payload into a plurality of audio symbols to form an audio transmission; generate an audio signal containing the plurality of audio symbols; and transmit the audio signal within the audio environment.

In some aspects, the techniques described herein relate to a method including detecting an audio transmission within an audio signal received from an audio environment; extracting the audio transmission from the audio signal; identifying a data payload of the audio transmission; deinterleaving the data payload according to a predetermined interleaving protocol to form deinterleaved data; decoding the deinterleaved data to form a decoded data payload; and extracting data from the decoded data payload.

In some aspects, the techniques described herein relate to a method further including, before decoding the deinterleaved data, removing a portion of the deinterleaved data that corresponds to supplementary data.

In some aspects, the techniques described herein relate to a method wherein the deinterleaved data is decoded according to a predetermined encoding protocol.

In some aspects, the techniques described herein relate to a method wherein deinterleaving the data payload includes extracting a header of the audio transmission and identifying, within the header of the audio transmission, an indication of the predetermined encoding protocol.

In some aspects, the techniques described herein relate to a method further including demodulating the data payload before deinterleaving the data payload.

In some aspects, the techniques described herein relate to a method further including demodulating the data payload after deinterleaving the data payload.

In some aspects, the techniques described herein relate to a method wherein decoding the deinterleaved data includes performing error detection and correction on the decoded data payload.

In some aspects, the techniques described herein relate to a method wherein decoding the deinterleaved data is performed by a Viterbi decoder configured to utilize an error checking code contained within the decoded data payload.

In some aspects, the techniques described herein relate to a method wherein detecting the audio transmission includes detecting a predetermined portion within the audio signal.

In some aspects, the techniques described herein relate to a method wherein extracting the audio transmission includes identifying, based on the predetermined portion, a portion of the audio signal corresponding to the audio transmission and extracting the portion of the audio signal.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes and not to limit the scope of the disclosed subject matter.

### BRIEF DESCRIPTION OF THE FIGURES

FIG. 1 illustrates a computing system according to exemplary embodiments of the present disclosure.

FIG. 2 illustrates an audio transmission according to an exemplary embodiment of the present disclosure.

FIG. 3 illustrates a system for communicating using audio transmissions according to an exemplary embodiment of the present disclosure.

FIGS. 4A-4D illustrate interleaving operations according to exemplary embodiments of the present disclosure.

FIG. 5A-5C illustrate modulation protocols according to exemplary embodiments of the present disclosure.

FIG. 6 illustrates a method for generating and transmitting interleaved audio transmissions according to an exemplary embodiment of the present disclosure.

FIG. 7 illustrates a method for receiving and processing interleaved audio transmissions according to an exemplary embodiment of the present disclosure.

FIG. 8 illustrates a computing system according to an exemplary embodiment of the present disclosure.

### DETAILED DESCRIPTION

Various techniques and systems exist to exchange data between computing devices without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired to transmit data according to these wireless communication protocols. Such communicative pairing can be cumbersome and slow, reducing the likelihood that users associated with one or both of the computing devices will utilize the protocols to transmit data.

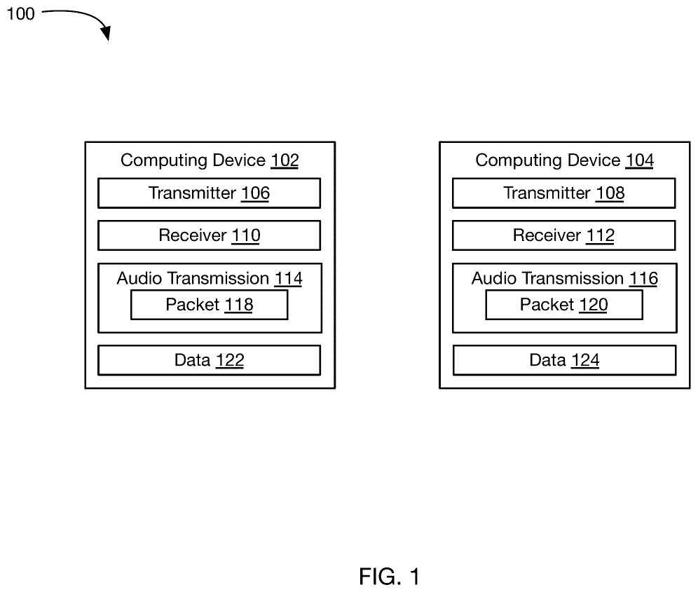

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers. In certain implementations, the transmitters 106, 108 may be implemented as a speaker built into the computing device 102, 104. For example, one or both of the computing devices may be a smart phone, tablet computer, and/or laptop with a built-in speaker that performs the functions of the transmitter 106, 108. In other implementations, the transmitters 106, 108 may be implemented as a microphone external to the computing device 102, 104. For example, the transmitters 106, 108 may be implemented as one or more speakers externally connected to the computing device 102, 104.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing device 102, 104. For example, one or both of the computing devices may be a smart phone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In certain implementations, the transmitter 106, 108 and receiver 110, 112 may be implemented as a single device connected to the computing device. For example, the transmitter 106, 108 and receiver 110, 112 may be implemented as a single device containing both a speaker and a microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112). In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

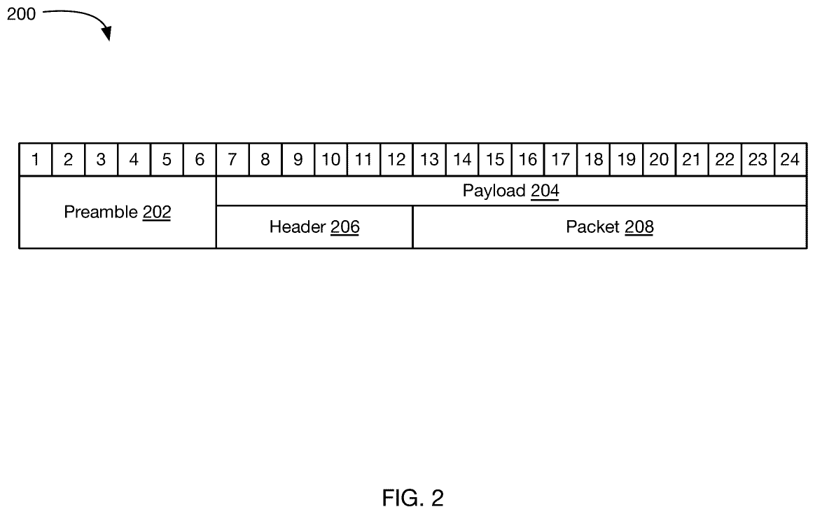

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 5 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated to encode information in the audio transmission 200 (e.g., certain frequencies may correspond to certain pieces of information). In another example, the phases of the frequencies may be additionally or alternatively be modulated to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined frequencies produced at predetermined points of time (e.g., according to a frequency pattern). In certain implementations, the preamble 202 may additionally or alternatively contain frequencies (e.g., a particular predetermined frequency) whose phase differences are altered by predetermined amounts at predetermined points of time (e.g., according to a phase difference pattern). The preamble 202 may be used to identify the audio transmission 200 to a computing device receiving the audio transmission 200. For example, a receiver of the computing device receiving audio transmissions, such as the audio transmission 200, may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align the processing of audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for the relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

The preamble 202 and the payload 204 may be modulated to form the audio transmission 200 using similar modulation protocols. Accordingly, the preamble 202 and the payload 204 may be susceptible to similar types of interference (e.g., similar types of frequency-dependent attenuation and/or similar types of frequency-dependent delays). Proper extraction of the payload 204 from the audio transmission 200 may rely on proper demodulation of the payload 204 from an audio carrier signal. Therefore, to accurately receive the payload 204, the computing device receiving the audio transmission 200 must account for the interference.

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

As explained above, audio transmissions are useful for transmitting data between computing devices in various circumstances (e.g., during periods of low wireless connectivity, to verify proximity between two or more computing devices, to avoid communicative pairing between multiple computing devices). In particular, advancements in audio transmission technologies have increased the size of data payloads that can be transmitted using audio transmissions. For example, improved equalization and error detection techniques for receiving computing devices have increased the overall length of audio transmission payloads that can be reliably transmitted between computing devices. In particular, such techniques have dramatically increased the overall length in data payloads. In certain implementations, these techniques quadrupled data payload lengths for audio transmissions from 8 bytes to 32 bytes. However, longer data payloads need to transmit for longer periods of time, making them more susceptible to various forms of interference. In particular, temporally concentrated audio interference (e.g., audio signal spikes, clapping sounds, banging sounds, and the like) may be particularly problematic for audio transmissions with long data payload durations. For instance, a brief audio spike that occurs during an audio transmission's broadcast can cause multiple reflections in close temporal proximity (e.g., audio interference that occurs over short periods of time, such as within 5 ms, within 10 ms, within 50 ms, within 100 ms) that generate too many errors in a particular portion of the audio transmission to be corrected using typical error processing techniques.

One solution to this problem is to generate data payloads for audio transmissions that utilize interleaved data. In particular, a transmitting computing device may receive data for transmission, generate an error checking code for the data, and interleave the data and error checking code to generate interleaved data. The interleaved data may then be modulated onto one or more audio symbols to generate a data payload for an audio transmission, which may be transmitted as an audio signal. In various instances, the data may be interleaved with various types of supplementary data. Interleaving the data in this manner spreads out adjacent data bits throughout a data payload. This reduces the chances that temporally concentrated audio interference that is localized in time (e.g., audio spikes and their associated reflections) has an adjacent or nearby data bits. The use of supplementary data may further spread out the desired data bits within interleaved data as well. When reconstituted by a receiving computing device, the interleaved data may be more likely to be successfully processed by error detection and correction techniques (e.g., decoding techniques), even when audio spike interference occurs during transmission.

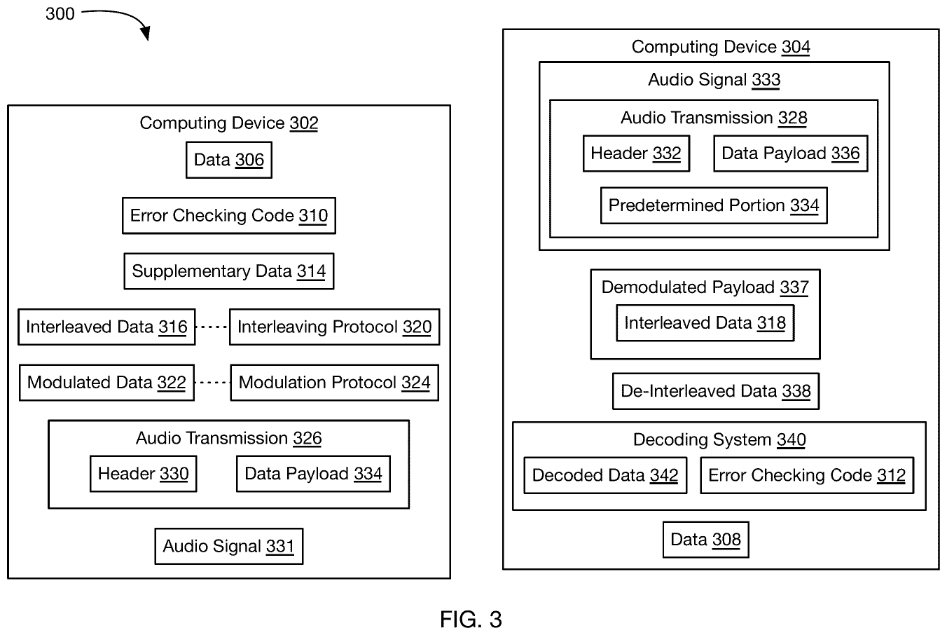

FIG. 3 illustrates a system 300 for communicating using audio transmissions according to an exemplary embodiment of the present disclosure. The system 300 includes computing devices 302, 304, which may be configured to communicate with one another using audio transmissions. In particular, the computing devices 302, 304 may be configured to utilize audio transmissions that contain interleaved data within data payloads. In the depicted example, the computing device 302 is configured to generate and transmit an audio transmission 326 and the computing device 304 is configured to receive and process an audio transmission 328 (e.g., a copy of the audio transmission 326). In practice the computing device is 302, 304 may each be configured to both transmit and receive audio transmissions.

The computing device 302 may receive and/or generate data 336 for transmission via audio transmission. The data 336 may contain an identifier of other information necessary to identify the computing device 302 and/or a user of the computing device 302. For example, the data 336 may be used to identify or process a request corresponding to a user of the computing device 302. The request may be a request for a service. The service may include a request to perform a computing service, a location-based service, and/or a financial service. Computing services may include one or more of generating, storing, retrieving, and/or manipulating data (e.g., data associated with a user of the computing device 302). Location-based services may include one or more services in which the user is required to be in a particular location to complete the service (e.g., rideshare services, order pickup and/or delivery services, dog walking services, home cleaning services). Financial services may include creating an order with a retailer, fulfilling an order with the retailer, creating and/or processing a payment on behalf of a user associated with the computing device 302, and the like. The request may be created by the computing device 302 and/or by a user associated with the computing device 302. Additionally or alternatively, a user associated with the computing device 302 may create the request using another computing device (not depicted). In certain instances, the request may not be created by the user but may be created on the user's behalf (e.g., by another user or individual, by an automated computing service).

The computing device 302 may generate an error checking code 310 for the data 306. For example, the error checking code 310 may be generated according to various error detection and/or correction protocols. For example, the error checking code 310 may be generated based on one or more of a checksum protocol, a cyclic redundancy check (CRC) protocol, an automatic repeat request protocol, a forward error correction protocol, and the like, or any combination of multiple error detection and correction protocols. In particular, the error checking code 310 may be generated as a CRC error checking and correction code for the combined contents of a data payload 334 of an audio transmission (e.g., the data 306 and any other data included within the data payload 334).

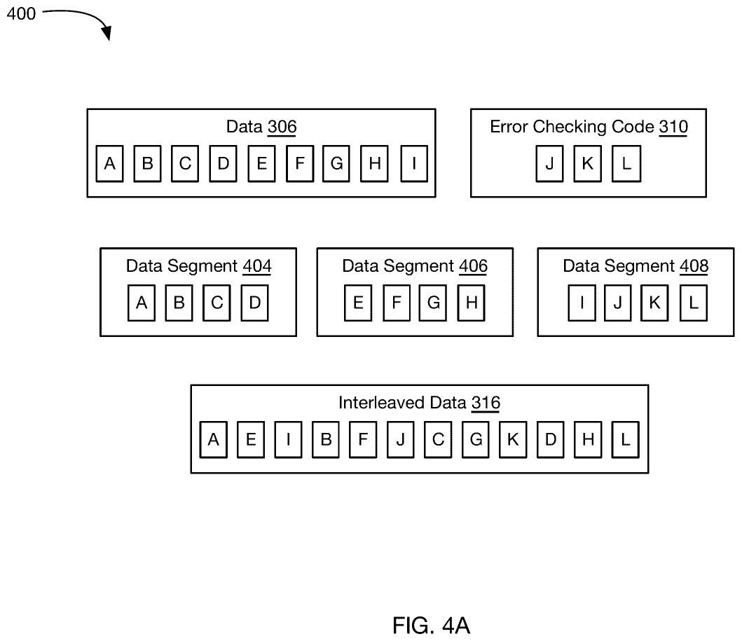

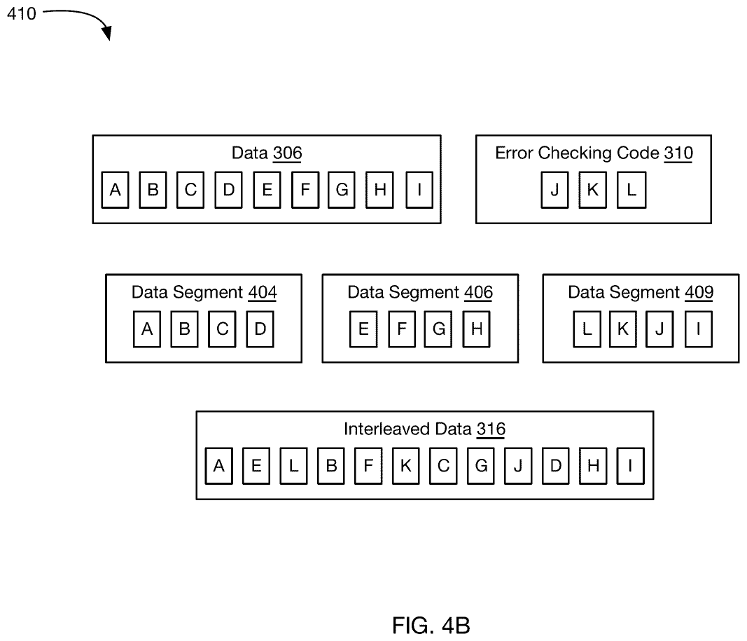

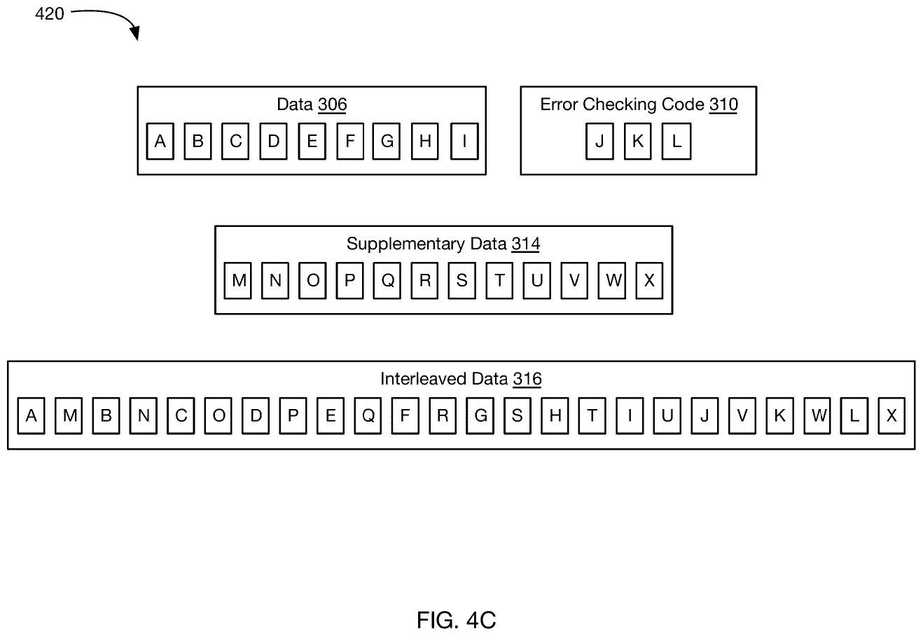

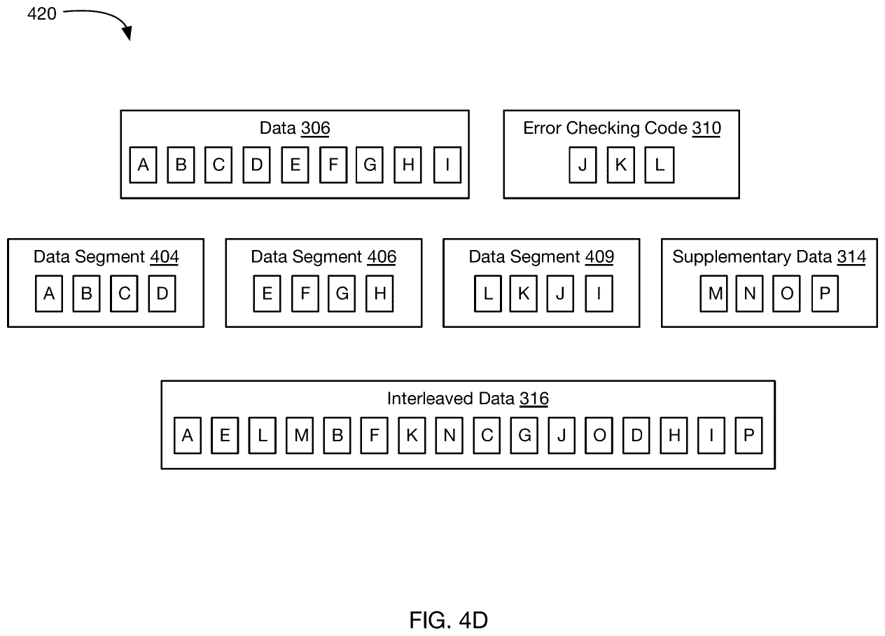

The computing device 302 may then interleave the data 306 to form interleaved data 316. For example, the computing device 302 may interleave the data 306 and the error checking code 310 to form the interleaved data 316. The data 306 may be interleaved according to an interleaving protocol 320. The interleaving protocol 320 may specify one or more of a symbol length of the audio symbols, a number of interleaved data segments, a length of a supplementary data segment, and/or an ordering of the interleaved data. For example, the interleaving protocol 320 may specify that the data 306 and/or the error checking code 310 is divided into one or more data segments that are interleaved together to form the interleaved data 316. In certain implementations, the interleaving protocol 320 may further specify that the data 306 is interleaved with supplementary data 314. For example, the supplementary data 314 may contain one or more of a copy of all or part of the data 306, a randomly generated data stream, a unique identifier associated with the data 306, and/or a shared secret between the computing device 302 and the computing device 304. In certain instances, the data may be interleaved and/or deinterleaved using a matrix (e.g., a deinterleaving matrix). In such instances, the interleaving protocol 320 may specify how the matrix is constructed (i.e., number of rows/columns). In particular, the data may be interleaved according to a random vector (e.g., a vector with randomly-selected dimensions). In such instances, the interleaving protocol 320 may specify the random vector (e.g., the randomly-selected dimensions). Such implementations may provide increased security for interleaved data (e.g., as compared to non-interleaved data, as compared to data interleaved according to various other interleaving protocols). Data interleaving is discussed in greater detail below in connection with FIGS. 4A-4D.

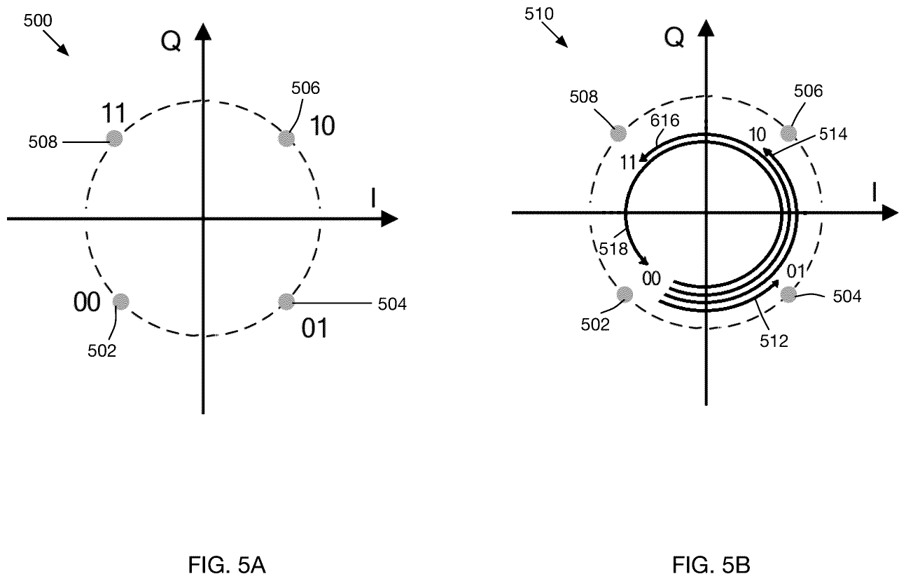

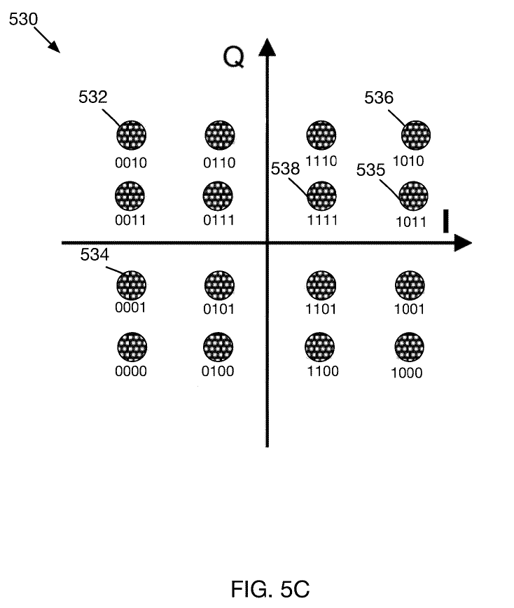

The computing device 302 may also generate modulated data 322. For example, the computing device 302 may modulate the interleaved data 316, according to a modulation protocol 324, to generate audio symbols for use in generating and transmitting an audio signal 331 for the audio transmission 326. Demodulation protocol 324 may specify one or more phases, phase differences, magnitudes, frequencies, and the like for various corresponding data bits. Modulation protocols are discussed in greater detail below in connection with FIGS. 5A-5C. In certain implementations, the interleaved data 316 may be modulated to form the modulated data 322. In additional or alternative implementations, the data 306 may be modulated before generating the interleaved data 316. For example, the data 306 and the error checking code 310 may be modulated according to the modulation protocol 324 to generate the modulated data 322. In such instances, the modulated data 322 may then be interleaved according to the interleaving protocol 320 to generate the interleaved data 316. In such instances, where supplementary data 314 is used, the supplementary data 314 may similarly be modulated according to the modulation protocol 324 to generate the modulated supplementary data that is interleaved with the modulated data 322 to form the interleaved data 316.

The computing device 302 may then form an audio transmission 326 to transmit the data 306. In particular, the audio transmission 326 may include a header 330 and a data payload 334. The data payload 334 may contain the modulated data 322 and/or the interleaved data 316. For example, where the computing device 302 is configured to generate the interleaved data 316 before the modulated data 322, the data payload 334 may be generated to include the modulated data 322. By contrast, where the computing device 302 is configured to generate the modulated data 322 before the interleaved data 316, the data payload 334 may be generated to contain the interleaved data 316. The header 330 may contain additional information regarding the audio transmission 326. For example, the header 330 may be generated to include routing information for the data 306 (e.g., for use by a receiving computing device upon receiving and extracting the data 306). Additionally or alternatively, the header 330 may be generated to include an indication of the interleaving protocol 320 and/or the modulation protocol 324. In further implementations, the header 330 may be generated to include an indication of an error detection and correction protocol used to generate the error checking code 310. Although not depicted, information contained within the header 330 may be modulated according to the modulation protocol 324 to generate audio symbols for the audio transmission 326.

The computing device 302 may then generate an audio signal 331 for the audio transmission 326. For example, the header 330 and the data payload 334 may contain one or more audio symbols (e.g., generated according to the modulation protocol 324). The audio signal 331 may be generated according to the audio characteristics identified by the audio symbols (e.g., frequencies, magnitudes, phases, and/or phase differences). The computing device 302 may then broadcast the audio signal 331 within an audio environment surrounding the computing device 302. An audio environment may include a physical space containing one or more computing devices capable of receiving and/or transmitting data using audio transmissions. The audio environment may include the physical space in which audio transmissions can be transmitted or received and may include one or more sources of audio interference (e.g., individuals, other computing devices, mechanical devices, electrical devices, speakers, and the like). In particular, the computing device 302 may be communicatively coupled to one or more transmitters (e.g., speakers, similar to the transmitters 106, 108) and may be configured to transmit the audio signal 331 via the transmitters.

The computing device 304 may then receive an audio transmission 328 (e.g., a copy of the transmission 328). In particular, the computing device 304 may be located within the audio environment surrounding the computing device 302 and may be configured to continuously monitor audio signals 333 received from the audio environment. In particular, the computing device 304 may be communicatively coupled to one or more receivers (e.g., microphones, similar to the receivers 110, 112), which may be configured to continuously receive and monitor audio signals 333 from the audio environment. In particular, in certain implementations, the computing device 304 may monitor the audio signal 333 for a predetermined portion 334 of the audio transmission 328. The predetermined portion 334 may represent an expected sequence of audio symbols and/or an expected audio signal, indicating the presence of an audio transmission 328. In certain implementations, the predetermined portion 334 may additionally or alternatively contain a training sequence of audio symbols that can be compared to an expected sequence of audio symbols in order to equalize the received audio transmission 328. In various implementations, the predetermined portion 334 may be common across multiple audio transmissions (e.g., for all audio transmissions sent or received by the computing devices 302, 304). Additionally or alternatively, the predetermined portion 334 may be unique to certain audio transmissions (e.g., may only be used for the audio transmission 326, 328, may only be used for audio transmissions sent and received by the computing device 302, may only be used for audio transmissions associated with a request corresponding to the data 306). In various implementations, the predetermined portion 334 may be located at the beginning of the audio transmission 328 (e.g., acting as a preamble 202), in the middle of the audio transmission 328, and/or at the end of the audio transmission 328.

The audio transmission 328 also contains a header 332 and a data payload 336. The header 332 and the data payload 336 may respectively represent received versions of the header 330 and the data payload 334. For example, the header 332 and/or the data payload 336 may experience one or more forms of interference (e.g., temporally concentrated audio interference, audio spikes, other sources of audio interference). The computing device 304 may be configured to process and extract the portions of the audio signal corresponding to the header 332 and the data payload 336 to extract and process data 308 (e.g., a copy of the data 306).

In particular, the computing device 304 may be configured to demodulate the data payload 336 to generate a demodulated payload 337. In particular, the computing device 304 may demodulate the data payload 336 according to the modulation protocol 324. The modulation protocol 324 may be predetermined (e.g., may be previously known by the computing device is 302, 304). In additional or alternative implementations, the computing device at 304 may determine the modulation protocol 324 based on the audio transmission 328. For example, the header 332 may include an indication of the modulation protocol 324. Additionally or alternatively, the computing device 304 may be configured to test or attempt demodulation according to multiple modulation protocols. For instance, the computing device 304 may also be configured to demodulate the header 332 (e.g., to extract information contained within the header 332).

The demodulating payload 337 may contain interleaved data 318, which may represent a received copy of the interleaved data 316. The computing device 304 may accordingly be configured to deinterleave the interleaved data 318 to generate deinterleaved data 338. For example, the computing device 304 may deinterleave the interleaved data 318 according to the interleaving protocol 320, which may have been previously determined and/or may be indicated within the contents of the header 332. In various implementations, the computing device 304 may additionally or alternatively be configured to perform the deinterleaving before demodulating the received data. For example, the computing device 304 may initially deinterleave the data payload 336 to generate the deinterleaved data 338. The deinterleaved data 338 may then be demodulated according to the modulation protocol 324 to generate the demodulated payload 337. In such instances, the demodulated payload 337 may contain an encoded copy of data to be extracted (e.g., when the data payload 334 is encoded by the computing device 302 according to an encoding protocol). For example, the data payload 334 may be encoded by the computing device 302 according to a predetermined convolution encoding protocol (e.g., a 2/3 convolution encoding protocol). In such instances, the computing device 304 may be configured to decode the demodulated payload 337 according to the same predetermined convolution encoding protocol.

As explained above, the computing device 302 may encode the data 306 and/or the error checking code 310 before generating the interleaved data 316 and/or the modulated data 322. Accordingly, after demodulating and deinterleaving the data payload 336, it may still be necessary to decode the resulting data (e.g., the deinterleaved data 338). The computing device 304 includes a decoding system 340 configured to decode the deinterleaved data 338 according to a predetermined encoding protocol. In particular, the decoding system 340 may be configured to extract an error checking code 312 from the deinterleaved data 338 and to decode deinterleaved data 338 into decoded data 342. One or more error detection and correction operations may be performed on the decoded data 342. For example, the decoding system 340 and/or the computing device 304 may be configured to detect and correct errors in the decoded data 342 using an error checking code 312 and a corresponding error detection and correction protocol used to generate the error checking code 312 (e.g., utilized by the computing device 302). In various implementations, the decoding system 340 may be implemented by a Viterbi decoder. For example, the decoding system 340 may be implemented as a seven symbol Viterbi decoder. In the above examples, the decoding system 340 is configured to decode the deinterleaved data 338. As explained above, in various implementations, the computing device 304 may be configured to deinterleave the data (e.g., generating the deinterleaved data 338 before demodulating). In such instances, the decoding system 340 may be additionally or alternatively configured to decode the demodulating data (e.g., the contents of a demodulated payload 337 generated based on the deinterleaved data 338.

In this way, the computing device 304 may extract the data 308 from an audio transmission 328 that contains interleaved data. As explained above, interleaving the contents of audio transmissions reduces the effects of the discrete and temporally concentrated sources of audio interference (e.g., banging noises, claps, audio spikes). In the examples discussed above, only the data payload 334, 336 of the audio transmission 326, 328 is interleaved. In additional or alternative implementations, the computing devices 302, 304 may be configured to generate and receive audio transmissions in which other portions are interleaved. As a specific example, various implementations may also interleave the contents of the headers 330, 332.

FIGS. 4A-4D illustrate interleaving operations 400, 410, 420, 430 according to exemplary embodiments of the present disclosure. The interleaving operations 400, 410, 420, 430 may be exemplary implementations of the operations performed by the computing device 302 to generate the interleaved data 316 based on received data 306. For example, the interleaving operations 400, 410, 420, 430 may represent interleaving operations performed according to different interleaving protocols 320.

Starting with FIG. 4A, the interleaving operation 400 is performed to interleave the data 306 and the error checking code 310 without any additional supplementary data 314. In the depicted example, the data 306 contains 9 data symbols A-I The computing device 302 generates an error checking code 310 for the data 306, which contains three data symbols J-L. For example, the computing device 302 may generate the error checking code 310 according to the cyclic redundancy check (CRC) protocol. It should be understood that the data symbols A-L are merely used for illustrative purposes. Notably, the contents of the data symbols are not depicted and may include any relevant data and error checking code for transmission. Furthermore, each of the data symbols may represent multiple bits of information. As a specific example, each of the data symbols may represent 4 bytes of data.

The computing device 302 may be configured to interleave the data 306 and the error checking code 310 by dividing the data into data segments 404, 406, 408 (e.g., data segments of equal length or similar length) and interleaving the data segments 404, 406, 408. For example, the computing device 302 may generate three data segments 404, 406, 408, each containing four data symbols. In particular, the data segment 404 contains the data symbols A-D from the data 306, the data segment 406 contains the data symbols E-H from the data 306, and the data segment 408 contains the symbol I from the data 306 and the symbols J-L from the error checking code 310. The computing device 302 may generate the interleaved data 316 by sequentially adding a data symbol from each of the data segments 404, 406, 408 in the order in which the data symbols appear in the data segments (e.g., the first data symbol A for the data segment 404, followed by the first data symbol E from the data segment 406, followed by the first data symbol I from the data segment 408, followed by the second data symbol B from the data segment 404, and so on). The resulting sequence of interleaved data 316 is shown in FIG. 4A

In certain implementations, the interleaving protocol 320 may call for the order of one or more of the data segments 404, 406, 408 to be changed. For example, the data segments may be reversed, shuffled, and the like, according to a predetermined ordering for the interleaving protocol 320. As one example, and turning to FIG. 4B, in the interleaving operation 410, the computing device 302 generates the same data segments 404, 406 as in the interleaving operation 400, but reverses the order of the data within the data segment 408, resulting in data segment 409. The interleaved data 316 may then be generated by sequentially adding data symbols from the data segments 404, 406, 409 in the order in which they appear, similar to the interleaving operation 400. The resulting sequence of interleaved data is shown in FIG. 4B.

Depending on how common audio interference is in an audio environment, it may not be sufficient to merely interleave the data 306 and the error checking code 310 alone. In particular, related portions of the data 306 may still experience enough interference to make accurate decoding and/or error detection and correction impossible (e.g., too many errors within adjacent or nearby bits of data even after interleaving). To further spread the data out, the computing device 302 may be configured to interleave the data 306 and the error checking code 310 with supplementary data 314. As one example, and turning to FIG. 4C, the supplementary data 314 contains data symbols. The supplementary data 314 may be generated as random data symbols. Additionally or alternatively, the supplementary data 314 may include an additional copy of the data 306 and/or the error checking code 310. For example, the supplementary data 314 may be a reversed copy of the data 306 and/or the error checking code 310. Additionally or alternatively, the supplementary data 314 may be generated to include other types of information (e.g., a unique identifier associated with the data 306, a shared secret between the computing devices 304). Once generated, the supplementary data 314 may be interleaved with the combined data 306 and error checking code 310 (e.g., where the error checking code 310 is appended to the end of the data 306). In particular, the interleaved data 316 may be generated by sequentially adding symbols from the data 306, the error checking code 310, and supplementary data 314 in the order in which the data symbols occur. The resulting interleaved data 316 is shown in FIG. 4C.

In the interleaving operation 420, the supplementary data 314 is the same length as the combined data 306 and error checking code 310. This may accordingly increase the overall bandwidth required for the audio transmission (e.g., by 30% or more, depending on the length of the combined data 306 and error checking code 310). In certain implementations (e.g., congested communication environments, data intensive applications), such an increase in audio transmission bandwidth may not be feasible or acceptable. In such instances, sequences of supplementary data 314 may be used that are shorter than the combined data 306 and error checking code 310. For example, and turning to FIG. 4D, the interleaving operation 430 uses supplementary data 314 that is only four data symbols long (e.g., one third as long as the supplementary data 314 used in the interleaving operation 420). The computing device 302 may be configured to split the combined data 306 and error checking code 310 into data segments that are approximately the same length as the supplementary data 314. For example, the computing device 302 may split the data 306 and error checking code 310 into the same data segments 404, 406, 410 used during the interleaving operation 410. Once generated, the data segments 404, 406, 410 and the supplementary data 314 may be interleaved by sequentially adding data symbols from each of the data segments 404, 406, 410 and the supplementary data 314 in the order in which the data symbols occur. The resulting interleaved data 316 is shown in FIG. 4D.

As shown above, and depicted in FIGS. 4A-4D, different interleaving protocols may result in consecutive data segments being distributed further apart within a resulting sequence of interleaved data. This improves robustness during transmission, particularly against temporally concentrated sources of audio interference (e.g., audio interference that occurs over short periods of time). As will be readily apparent to one skilled in the art in light of the above discussion, many different types of interleaving protocols may be used, including different numbers of data segments, different ordering of data contents within the data segments, and different strategies for interleaving data from different data segments. Any such interleaving protocols are expressly considered within the scope of the present disclosure. Furthermore, multiple interleaving protocols may be combined in various implementations.

FIGS. 5A-5C illustrate modulation protocols 500, 510, 530 according to exemplary embodiments of the present disclosure. In particular, FIG. 5A depicts a phase shift keying (PSK) modulation protocol 500, FIG. 5B depicts a differential phase shift keying (DPSK) modulation protocol 510, and FIG. 5C depicts a quadrature amplitude modulation (QAM) modulation protocol. The modulation protocols 500, 510, 530 may be used to modulate data (e.g., digital data bits) into one or more audio symbols (e.g., combinations of phase, frequency, and/or magnitude). The modulation protocols 500, 510, 530 may be used to generate analog audio signals, such as audio signals 331, 333. In various implementations, one or more of the modulation protocols 500, 510, 530 may be exemplary implementations of the modulation protocol 324.

The PSK modulation protocol 500 may encode symbols as particular phases 502, 504, 506, 508 for corresponding symbols within analog audio signals. In particular, FIG. 5A depicts the modulation protocol 500 in a constellation diagram that depicts phases 502, 504, 506, 508 as combinations of an in-phase carrier (I) and a quadrature carrier (Q), where the quadrature carrier is shifted by 90 degrees from the in-phase carrier. In the constellation diagram, different phases 502, 504, 506, 508 may be depicted as different angles within the constellation diagram. In particular, the symbols are each separated by 90 degrees. As a specific example, phase 506 may include positive components of both the in-phase carrier and the quadrature carrier with the same magnitude. A symbol in a corresponding analog audio signal may be encoded according to a corresponding phase 502, 504, 506, 508. As specific example, a symbol containing “00” may be encoded as phase 502, a symbol containing “01” may be encoded as phase 504, a symbol containing “10” may be encoded as phase 506, and a symbol containing “11” may be encoded as phase 508.

As depicted, the PSK protocol 500 encodes two-bit symbols and therefore can encode up to four different types of symbols. Accordingly, the PSK protocol 500 may also be referred to as a Quad-PSK (QPSK) protocol. However, in additional or alternative implementations, PSK protocols may be used that encode longer or shorter symbols. For example, an 8 PSK protocol may be used that supports three-bit symbols and can therefore encode up to eight different types of symbols. Symbols in an 8 PSK protocol may be separated by 45 degrees on a constellation diagram. As another example, a binary-PSK (BPSK) protocol may be used that supports one-bit symbols and can encode up to two different types of symbols. Symbols in a DPSK protocol may be separated by 180 degrees on a constellation diagram.

The DPSK protocol 510 may encode symbols as differences in phases between consecutive symbols of a corresponding analog audio signal. In particular, FIG. 5B depicts the DPSK protocol 510 in a constellation diagram. As shown in the modulation protocol, a symbol containing “00” may be encoded as a phase difference 512 of 90 degrees between consecutive symbols, a symbol containing “01” may be encoded as a phase difference 514 of 180 degrees between consecutive symbols, a symbol containing “10” may be encoded as a phase difference 516 of 270 degrees between consecutive symbols, and a symbol containing “11” may be encoded as a phase difference 518 of 360 degrees (i.e., the same phase) between consecutive symbols. As a specific example, if a previous symbol of an analog audio signal was generated with phase 502, and the next symbol of the digital data bitstream contains “10”, the next symbol of the analog audio signal will be generated with a phase difference 514 of 180 degrees at phase 506. As a further example, if the next symbol of the digital data bitstream contains “11”, the next symbol of the analog audio signal will be generated with a phase difference 516 of 270 degrees at phase 504.

As depicted, the DPSK protocol 510 encodes two-bit symbols and therefore can encode up to four different types of symbols. Accordingly, the DPSK protocol 510 may also be referred to as a Quad-DPSK (QDPSK) protocol. However, in additional or alternative implementations, DPSK protocols may be used that encode longer or shorter symbols. For example, an 8 DPSK protocol may be used that supports three-bit symbols and can therefore encode up to eight different types of symbols. As another example, a binary-DPSK (BDPSK) protocol may be used that supports one-bit symbols and can encode up to two different types of symbols.

The QAM protocol 530 may encode symbols as particular combinations of phases and magnitudes for symbols of a corresponding analog audio signal. In particular, FIG. 5C depicts the QAM protocol 530 in a constellation diagram that depicts symbols 532, 534, 535, 536, 538 (only a subset of which are numbered) as combinations of an in-phase carrier (I) and a quadrature carrier (Q), where the quadrature carrier is shifted by 90 degrees from the in-phase carrier. In the constellation diagram, different phases for symbols may be depicted as different angles within the constellation diagram and different magnitudes may be depicted as different lengths from the origin of the constellation diagram to the symbols 532, 534, 535, 536, 538. For example, symbols 538 and 536 may have the same phase but different magnitudes, and symbols 532 and 536 may have the same magnitude but different phases. A symbol in a corresponding analog audio signal may be encoded according to a corresponding phase and magnitude. As a specific example, a symbol containing “1010” may be encoded as the phase and magnitude indicated by symbol 536 (e.g., equal parts of the I and Q carriers with a larger magnitude). As another example, a symbol containing “1111” may be encoded as the phase and magnitude indicated by symbol 538 (e.g., equal parts of the I and Q carriers with a smaller magnitude).

As depicted, the QAM protocol 530 encodes four-bit symbols and therefore can encode up to 16 different types of symbols. Accordingly, the QAM protocol 530 may also be referred to as a 16 QAM protocol. However, in additional or alternative implementations, QAM protocols may be used that encode longer or shorter symbols. For example, an 8 QAM protocol may be used that supports three-bit symbols and can therefore encode up to eight different types of symbols. As another example, a 32 QAM protocol may be used that supports five-bit symbols and can therefore encode up to 32 different types of symbols.

It should also be understood that the PSK, DPSK, and QAM protocols 500, 510, 530 depicted in FIGS. 5A-5C are merely exemplary and that other implementations, including other implementations of QPSK, QDPSK, and 16 QAM protocols, may be used. For example, in alternative implementations, a QPSK protocol may be used that includes different phases, or different symbols assigned to each of the phases, than the PSK protocol 500. As another example, in alternative implementations, a QDPSK protocol may be used that includes different phase differences than the DPSK protocol 500. As a further example, in alternative implementations, a 16 QAM protocol may be used that includes different combinations of phases and magnitudes than the QAM protocol 530. All such protocols are considered within the scope of the present disclosure.

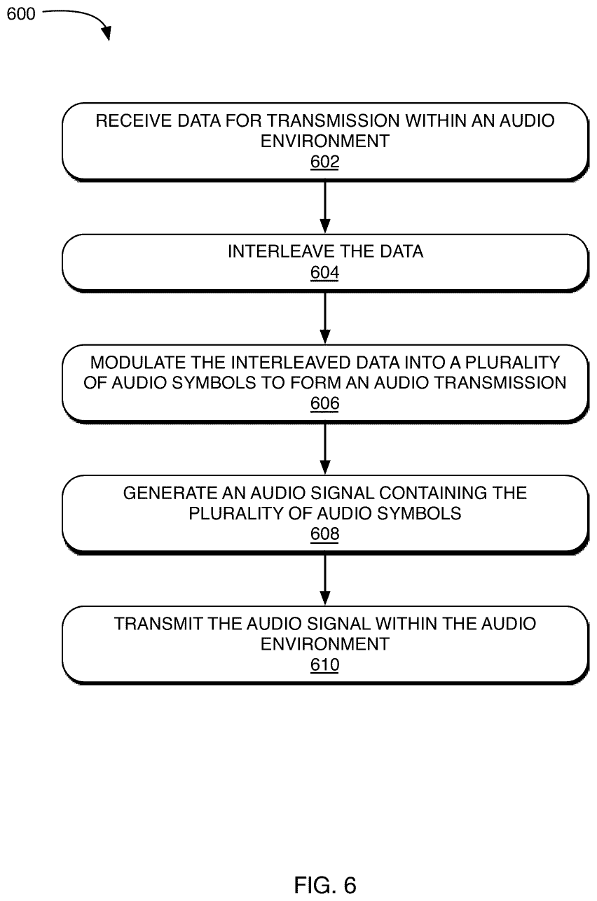

FIG. 6 illustrates a method 600 for generating and transmitting interleaved audio transmissions according to an exemplary embodiment of the present disclosure. The method 400 may be implemented on a computer system, such as the system 300. For example, the method 400 may be implemented by the computing devices 302, 304. The method 400 may also be implemented by a set of instructions stored on a computer readable medium that, when executed by a processor, causes the computing device to perform the method 400. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

The method 600 may begin with receiving data for transmission within an audio environment (block 602). For example, the computing device 302 may receive data 306 for transmission within an audio environment surrounding the computing device 302. The audio environment may contain both the computing device 302 and the computing device 304 and/or may contain one or more additional computing devices. The computing device 302 may receive and/or generate the data 336 as part of creating a request for a service.

The data may be interleaved to form a data payload (block 604). For example, the computing device 302 may interleave the data 306 to generate interleaved data 316. As described further above, interleaving the data 306 may be performed according to an interleaving protocol 320. Furthermore, interleaving the data 306 may include dividing the data 306 into multiple data segments and interleaving the data segments with one another. In certain implementations, the data may be encoded (e.g., according to a predetermined encoding protocol) before being interleaved. Additionally or alternatively, an error checking code 310 may be generated for the data 306 and may be interleaved with the data 306 to form the interleaved data 316. Additionally or alternatively, interleaving the data 306 may include generating or retrieving supplementary data 314, which may be interleaved with the data 306 to form the interleaved data 316.

The interleaved data may be modulated into a plurality of audio symbols to form an audio transmission (block 606). For example, the computing device 302 may modulate the interleaved data 316 into modulated data 322 containing a plurality of audio symbols for inclusion within the audio transmission 326. The modulated data 322 may be generated according to a modulation protocol 324, such as a PSK, DPSK, and/or QAM modulation protocol. As mentioned above, in various implementations, the data 306 may be modulated before the interleaved data 316 is generated. In such instances, block 606 may be performed before block 604.

An audio signal may be generated that contains the plurality of audio symbols (block 608). For example, the computing device 302 may generate an audio signal 331 containing the plurality of audio signals contained within the modulated data 322. For example, the computing device 302 may assemble an audio transmission 326 including a data payload 334 (e.g., containing a modulated and interleaved copy of the data 306) and a header 330. Each of the data payload 334 and the header 330 may be modulated (e.g., according to the modulation protocol 324) to generate a plurality of audio symbols. The audio symbols may be converted into a corresponding audio signal 331 (e.g., an audio signal generated to comply with one or more magnitudes, phases, frequencies, and/or phase differences specified by the audio symbols).

The audio signal may be transmitted within the audio environment (block 610). For example, the computing device 302 may transmit the audio signal 331 within the audio environment surrounding the computing device 302. The audio signal 331 may be transmitted using one or more audio transmitters communicatively coupled to the computing device 302 (e.g., one or more speakers or transducers).

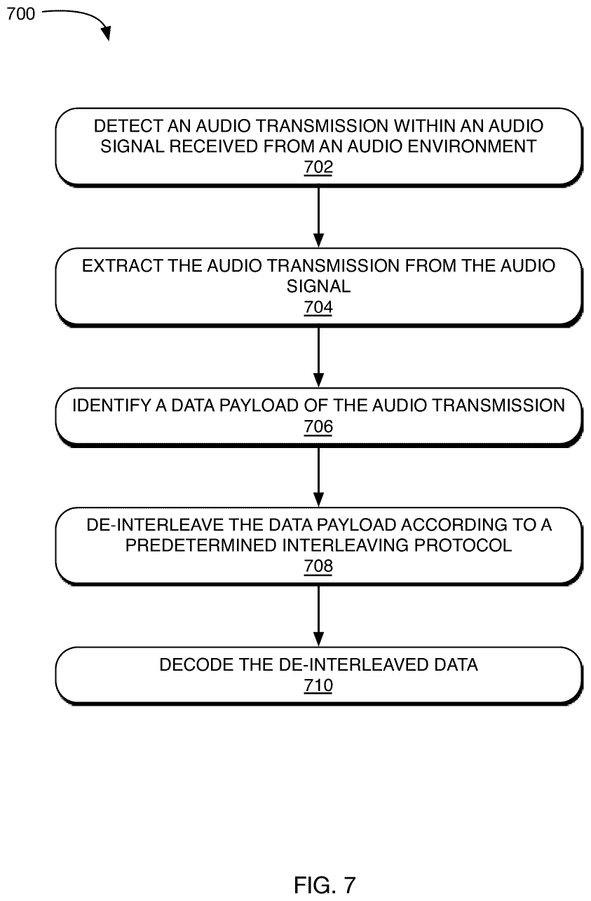

FIG. 7 illustrates a method 700 for receiving and processing interleaved audio transmissions according to an exemplary embodiment of the present disclosure. The method 700 may be implemented on a computer system, such as the system 300. For example, the method 700 may be implemented by the computing devices 302, 304. The method 700 may also be implemented by a set of instructions stored on a computer readable medium that, when executed by a processor, causes the computing device to perform the method 700. Although the examples below are described with reference to the flowchart illustrated in FIG. 7, many other methods of performing the acts associated with FIG. 7 may be used. For example, the order of some of the blocks may be changed, certain blocks may be combined with other blocks, one or more of the blocks may be repeated, and some of the blocks may be optional.

The method 700 begins with detecting an audio transmission within an audio signal received from an audio environment (block 702). For example, the computing device 304 may detect an audio transmission within an audio signal 333 received from an audio environment surrounding the computing device 304. For example, the computing device 304 may include one or more audio receivers configured to continuously receive audio signals 344 from a surrounding audio environment. The computing device 304 may monitor the audio signals 344 captured by the audio receivers for audio transmissions and may detect the received audio transmission 316 within the audio signal 344. For example, the computing device 304 may detect a predetermined portion 334 within the audio signal 344 and may, based on the predetermined portion, determine that the audio signal 344 contains an audio transmission 328

The audio transmission may be extracted from the audio signal (block 704). For example, the computing device 304 may extract the audio transmission from the audio signal 704. In particular, the computing device 304 may identify, based on when the audio transmission 328 is detected within the audio signal 344, a portion of the audio signal 344 that contains the audio transmission 328. For example, the computing device 304 may identify, based on when the predetermined portion is detected, a portion of the audio signal 344 that contains the audio transmission 328. The identified portion of the audio signal 344 may then be extracted from the audio signal (e.g., copied for further processing).

A data payload of the audio transmission may be identified (block 706). For example, the computing device 304 may identify a data payload 336 contained within the audio transmission 328. The data payload 336 may be identified as a portion of the audio signal 333, beginning at least a predetermined amount after the beginning of the audio transmission 328. In certain instances, a length of the data payload 336 may not be known. In such instances, the header 332 may contain a payload length for the data payload 336. The payload length may be used to identify the portion of the audio signal 333 that correspond to the data payload 336.

The data payload may be deinterleaved according to a predetermined interleaving protocol (block 708). For example, the computing device 304 may deinterleave the data payload 336 according to a predetermined interleaving protocol 320. To generate deinterleaved data 338, deinterleaving the data payload 336 may include reversing the operations performed to interleave the data 306 according to the interleaving protocol 320. For example, the computing device 304 may separate data contents (e.g., data symbols contained within the data payload 336) in two separate data segments, which may then be combined to form the deinterleaved data 338. In certain instances, the ordering of data within the data segments themselves may need to be altered (e.g., reversed, unshuffled, and the like). In certain implementations, deinterleaving the data may also include disregarding all or part of the deinterleaved data 338. For example, where the interleaving protocol 320 utilized supplementary data 314, deinterleaving the data payload 336 may include removing or discarding a portion of the deinterleaved data 338 corresponding to the supplementary data 314. In certain instances, the data payload 336 may be demodulated before being deinterleaved. In such instances, interleaved data 318 from the demodulated payload 337 may be deinterleaved according to the interleaving protocol 320 to generate the deinterleaved data 338 (e.g., instead of the data payload 336 itself). Additionally or alternatively, the deinterleaved data 338 may be modulated instead.

The deinterleaved data may be decoded (block 710). For example, the computing device 304 may decode the deinterleaved data 338 according to a predetermined encoding protocol. For example, the deinterleaved data 338 may be decoded by a decoding system 340 of the computing device 304 to generate decoded data 342 and an error checking code 312, as described above. In various implementations, the decoding system 340 may be further configured to perform one or more error detection and correction operations to generate an accurate copy of the data 308.

In this way, the methods 600, 700 enable computing devices to communicate using audio transmissions that contain interleaved contents. Interleaving the data contents improves the robustness of audio transmissions to various forms of audio interference, including temporarily concentrated audio interference. This improves the reliability of communication that utilizes audio transmissions. Furthermore, it enables longer audio transmissions to be used, as longer audio transmissions are more susceptible to temporally concentrated audio interference. These techniques thus increase the overall bandwidth available to computing devices that communicate using audio transmissions.

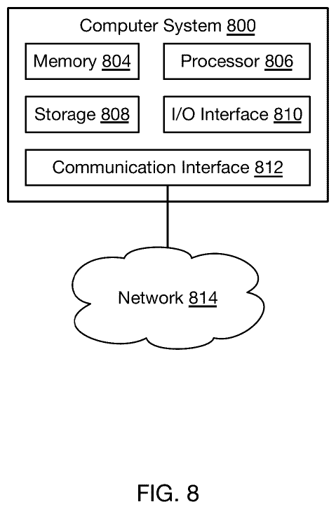

FIG. 8 illustrates an example computer system 800 that may be utilized to implement one or more of the devices and/or components discussed herein, such as the computing devices 102, 104, 302, 304. In particular embodiments, one or more computer systems 800 perform one or more steps of one or more methods described or illustrated herein. In particular embodiments, one or more computer systems 800 provide the functionalities described or illustrated herein. In particular embodiments, software running on one or more computer systems 800 performs one or more steps of one or more methods described or illustrated herein or provides the functionalities described or illustrated herein. Particular embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates the computer system 800 taking any suitable physical form. As example and not by way of limitation, the computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example, and not by way of limitation, one or more computer systems 800 may perform in real time, or in batch mode, one or more steps of one or more methods described or illustrated herein. One or more computer systems 800 may perform at different times or at different locations one or more steps of one or more methods described or illustrated herein, where appropriate.

In particular embodiments, computer system 800 includes a processor 806, memory 804, storage 808, an input/output (I/O) interface 810, and a communication interface 812. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 806 includes hardware for executing instructions, such as those making up a computer program. As an example, and not by way of limitation, to execute instructions, the processor 806 may retrieve (or fetch) the instructions from an internal register, an internal cache, memory 804, or storage 808; decode and execute the instructions; and then write one or more results to an internal register, internal cache, memory 804, or storage 808. In particular embodiments, the processor 806 may include one or more internal caches for data, instructions, or addresses. This disclosure contemplates the processor 806 including any suitable number of any suitable internal caches, where appropriate. As an example, and not by way of limitation, the processor 806 may include one or more instruction caches, one or more data caches, and one or more translation lookaside buffers (TLBs). Instructions in the instruction caches may be copies of instructions in memory 804 or storage 808, and the instruction caches may speed up retrieval of those instructions by the processor 806. Data in the data caches may be copies of data in memory 804 or storage 808 that are to be operated on by computer instructions, the results of previous instructions executed by the processor 806 that are accessible to subsequent instructions or for writing to memory 804 or storage 808, or any other suitable data. The data caches may speed up read or write operations by the processor 806. The TLBs may speed up virtual-address translation for the processor 806. In particular embodiments, processor 806 may include one or more internal registers for data, instructions, or addresses. This disclosure contemplates the processor 806 including any suitable number of any suitable internal registers, where appropriate. Where appropriate, the processor 806 may include one or more arithmetic logic units (ALUs), be a multi-core processor, or include one or more processors 806. Although this disclosure describes and illustrates a particular processor, this disclosure contemplates any suitable processor.

In particular embodiments, the memory 804 includes main memory for storing instructions for the processor 806 to execute or data for processor 806 to operate on. As an example, and not by way of limitation, computer system 800 may load instructions from storage 808 or another source (such as another computer system 800) to the memory 804. The processor 806 may then load the instructions from the memory 804 to an internal register or internal cache. To execute the instructions, the processor 806 may retrieve the instructions from the internal register or internal cache and decode them. During or after execution of the instructions, the processor 806 may write one or more results (which may be intermediate or final results) to the internal register or internal cache. The processor 806 may then write one or more of those results to the memory 804. In particular embodiments, the processor 806 executes only instructions in one or more internal registers or internal caches or in memory 804 (as opposed to storage 808 or elsewhere) and operates only on data in one or more internal registers or internal caches or in memory 804 (as opposed to storage 808 or elsewhere). One or more memory buses (which may each include an address bus and a data bus) may couple the processor 806 to the memory 804. The bus may include one or more memory buses, as described in further detail below. In particular embodiments, one or more memory management units (MMUs) reside between the processor 806 and memory 804 and facilitate accesses to the memory 804 requested by the processor 806. In particular embodiments, the memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory implementations, this disclosure contemplates any suitable memory implementation.

In particular embodiments, the storage 808 includes mass storage for data or instructions. As an example, and not by way of limitation, the storage 808 may include a hard disk drive (HDD), a floppy disk drive, flash memory, an optical disc, a magneto-optical disc, magnetic tape, or a Universal Serial Bus (USB) drive or a combination of two or more of these. The storage 808 may include removable or non-removable (or fixed) media, where appropriate. The storage 808 may be internal or external to computer system 800, where appropriate. In particular embodiments, the storage 808 is non-volatile, solid-state memory. In particular embodiments, the storage 808 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 808 taking any suitable physical form. The storage 808 may include one or more storage control units facilitating communication between processor 806 and storage 808, where appropriate. Where appropriate, the storage 808 may include one or more storages 808. Although this disclosure describes and illustrates particular storage, this disclosure contemplates any suitable storage.

In particular embodiments, the I/O Interface 810 includes hardware, software, or both, providing one or more interfaces for communication between computer system 800 and one or more I/O devices. The computer system 800 may include one or more of these I/O devices, where appropriate. One or more of these I/O devices may enable communication between a person (i.e., a user) and computer system 800. As an example, and not by way of limitation, an I/O device may include a keyboard, keypad, microphone, monitor, screen, display panel, mouse, printer, scanner, speaker, still camera, stylus, tablet, touch screen, trackball, video camera, another suitable I/O device, or a combination of two or more of these. An I/O device may include one or more sensors. Where appropriate, the I/O Interface 810 may include one or more device or software drivers enabling processor 806 to drive one or more of these I/O devices. The I/O interface 810 may include one or more I/O interfaces 810, where appropriate. Although this disclosure describes and illustrates a particular I/O interface, this disclosure contemplates any suitable I/O interface or combination of I/O interfaces.

In particular embodiments, communication interface 812 includes hardware, software, or both providing one or more interfaces for communication (such as, for example, packet-based communication) between computer system 800 and one or more other computer systems 800 or one or more networks 814. As an example, and not by way of limitation, communication interface 812 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 814 and any suitable communication interface 812 for the network 814. As an example, and not by way of limitation, the network 814 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 812 for any of these networks, where appropriate. Communication interface 812 may include one or more communication interfaces 812, where appropriate. Although this disclosure describes and illustrates a particular communication interface implementation, this disclosure contemplates any suitable communication interface implementation.

The computer system 802 may also include a bus. The bus may include hardware, software, or both and may communicatively couple the components of the computer system 800 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving data for transmission within an audio environment;
interleaving the data to form interleaved data;
modulating the interleaved data into a plurality of audio symbols to form an audio transmission;
generating an audio signal containing the plurality of audio symbols; and
transmitting the audio signal within the audio environment.

2. The method of claim 1, wherein interleaving the data includes interleaving the data with supplementary data to form the interleaved data.

3. The method of claim 2, wherein the supplementary data is a random data sequence with the same length as the data.

4. The method of claim 2, wherein the supplementary data is a unique identifier associated with the data.

5. The method of claim 1, wherein interleaving the data includes dividing the data into a plurality of data segments and interleaving the plurality of data segments to form the interleaved data.

6. The method of claim 5, wherein the data is divided into at least three data segments.

7. The method of claim 5, wherein interleaving the data includes reversing at least one of the plurality of data segments.

8. The method of claim 1, wherein the data is modulated into audio symbols before being interleaved to form the interleaved data.

9. The method of claim 1, wherein the data is encoded according to a predetermined encoding protocol before being interleaved to form the interleaved data.

10. The method of claim 9, further comprising, prior to interleaving the data, generating an error checking code for the data, and wherein interleaving the data comprises interleaving the error checking code with the data to form the interleaved data.

11. The method of claim 1, wherein the interleaved data is combined with header information before being modulated to form the audio transmission.

12. The method of claim 11, wherein the header information indicates that a data payload was interleaved.

13. The method of claim 12, wherein the data is interleaved according to a predetermined interleaving protocol, and wherein the header information is generated to indicate the predetermined interleaving protocol.

14. The method of claim 13, wherein the predetermined interleaving protocol specifies one or more of a symbol length of the audio symbols, a number of interleaved data segments, a length of a supplementary data segment, and/or an ordering of the interleaved data.

15. A system comprising:
a processor; and
a memory storing instructions which, when executed by the processor, cause the processor to:
receive data for transmission within an audio environment;
interleave the data to form a data payload;
modulate the data payload into a plurality of audio symbols to form an audio transmission;
generate an audio signal containing the plurality of audio symbols; and
transmit the audio signal within the audio environment.

16. A method comprising:
detecting an audio transmission within an audio signal received from an audio environment;
extracting the audio transmission from the audio signal;
identifying a data payload of the audio transmission;
deinterleaving the data payload according to a predetermined interleaving protocol to form deinterleaved data;
decoding the deinterleaved data to form a decoded data payload; and
extracting data from the decoded data payload.

17. The method of claim 16, further comprising, before decoding the deinterleaved data, removing a portion of the deinterleaved data that corresponds to supplementary data.

18. The method of claim 16, wherein the deinterleaved data is decoded according to a predetermined encoding protocol.

19. The method of claim 18, wherein deinterleaving the data payload comprises:
extracting a header of the audio transmission; and
identifying, within the header of the audio transmission, an indication of the predetermined encoding protocol.

20. The method of claim 16, further comprising demodulating the data payload before deinterleaving the data payload.
